(19) United States
(12) Patent Application Publication
(10) Pub. No.: US 2008/0112077 A1
(43) Pub. Date: May 15, 2008

(54) MULTI-CHANNEL HEAD AND METHOD FOR MANUFACTURING THE SAME

(75) Inventors: Kazuhiko Maejima, Tokyo (JP); Hiraku Hirabayashi, Tokyo (JP); Yoshiyuki Mizoguchi, Tokyo (JP); Nobuya Oyama, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TDK CORPORATION, Tokyo (JP)

(21) Appl. No.: 11/868,699

(22) Filed: Oct. 8, 2007

(30) Foreign Application Priority Data
Nov. 10, 2006 (JP) 2006-305210

(51) Int. Cl. G11B 5/187

(52) U.S. Cl. 360/122

(57) ABSTRACT

A multi-channel head includes at least one head chip. The head chip has a plurality of elements and at least one bonding interface, and the head chip has at least one element on one side of the bonding interface and at least one element on the other side of the bonding interface.

### BACKGROUND OF THE INVENTION

1. Field of the Invention

The present invention relates to a multi-channel head with a plurality of write elements and a plurality of read elements.

2. Description of the Related Art

In the computer field, data storage devices for performing recording/reproducing of magnetic information on and from a linear tape have been developed as a device for backing up data. Japanese Unexamined Patent Application Publication No. 2005-276267 discloses a multi-channel head to be used in such a data storage device.

In such a multi-channel head, a plurality of write elements and a plurality of read elements are arranged in a direction perpendicular to a linear tape travel direction. More specifically, one write element and one read element constitute one element pair, and a plurality of such element pairs are arranged in a direction perpendicular to a linear tape travel direction.

Because of having a plurality of write elements and a plurality of read elements, however, the yield of the above multi-channel head becomes much lower than that of an ordinary magnetic head having a single write element and a single read element for performing reading/writing, for example, in a hard disk drive.

More specifically, if the write element itself has a yield of X (0<x<1), the ordinary magnetic head will also have a yield of X with respect to the write element. However, a multi-channel head, for example, having “n” write elements will have a considerably decreased yield of Xⁿ with respect to the write element. Since this is also true for the read element, the multi-channel head will have a considerably lower yield than the ordinary magnetic head.

### SUMMARY OF THE INVENTION

The present invention has been devised in view of the above problem and has an object to provide a method for manufacturing a multi-channel head which enables improvement in yield and so on.

In order to achieve the above object, the present invention provides a multi-channel head comprising at least one head chip having a plurality of elements and at least one bonding interface,

wherein the head chip has at least one element on one side of the bonding interface and at least one element on the other side of the bonding interface.

The present invention also provides a magnetic media device comprising:

the above multi-channel head;

a magnetic medium facing the multi-channel head; and

a drive system for relatively moving the magnetic medium and the multi-channel head.

In order to achieve the same object, the present invention provides a method for manufacturing a multi-channel head having at least one head chip, comprising:

preparing a plurality of laminates each having at least one element; and

bonding together the plurality of laminates into the one head chip.

According to the present invention, the multi-channel head can be manufactured with a high yield.

It should be noted that other features of the present invention and their effects and advantages will be described in more detail with reference to the embodiments and the accompanying drawings.

### BRIEF DESCRIPTION OF THE DRAWINGS

FIG. 1 is a view showing a multi-channel head according to the present invention;

FIG. 2 is an enlarged view showing a portion including element pairs in a head chip and being an end view seen from a medium-facing surface side;

FIG. 3 illustrates separate deposition of write and read elements using different wafers;

FIG. 4 illustrates bonding of write and read element blocks;

FIG. 5 is a view of a head chip formed by bonding together write and read element blocks;

FIG. 6 illustrates a case where a projection and a recess are used for positioning write and read element blocks upon the bonding;

FIGS. 7A and 7B illustrate a case where electrical characteristics are used for positioning write and read element blocks upon the bonding;

FIGS. 8A and 8B illustrate a case where a coil is used for positioning write and read element blocks upon the bonding;

FIGS. 9A and 9B illustrate a case where a magneto-resistive element is used for positioning write and read element blocks upon the bonding;

FIG. 10A is a view showing main components of a magnetic media device, and FIG. 10B is an enlarged view showing a portion including a multi-channel head;

FIG. 11 illustrates a modification of the head chip;

FIG. 12 illustrates another modification of the head chip;

FIG. 13 illustrates still another modification of the head chip;

FIG. 14 illustrates yet another modification of the head chip;

FIG. 15 illustrates yet another modification of the head chip;

FIG. 16 illustrates yet another modification of the head chip;

FIG. 17 illustrates yet another modification of the head chip; and

FIG. 18 illustrates yet another modification of the head chip.

### DESCRIPTION OF THE PREFERRED EMBODIMENTS

Hereinbelow embodiments of the present invention will be described with reference to the accompanying drawings. In the drawings, the same reference symbols denote the same or corresponding portions. Throughout the description and claims, a vertical direction is a direction parallel to a deposition direction, wherein “lower” refers to a side where earlier layers are deposited, while “upper” refers to a side where later layers are deposited.

The multi-channel head of the present embodiment is applicable to a magnetic tape recorder such as of LTO (linear tape-open) technology for backing up data of computer, as a magnetic head for recording and reproducing magnetic information on and from a linear tape being a magnetic medium.

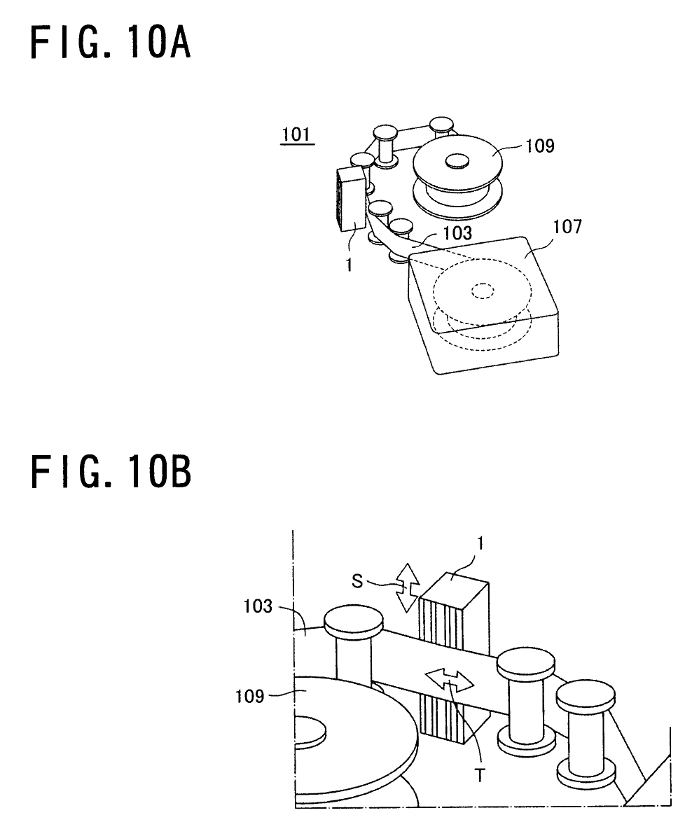

Referring to FIGS. 10A and 10B, first will be described a magnetic media device using a multi-channel head.

A magnetic media device 101 comprises a multi-channel head 1, a magnetic medium 103 facing the multi-channel head, and a drive system 105 for relatively moving the magnetic medium 103 such as a linear tape and the multi-channel head 1.

The drive system 105 further includes a single-reel tape cartridge 107 and a take-up reel 109 for temporarily winding up the magnetic medium 103 unwound from the tape cartridge 107. The magnetic medium 103 is concretely a magnetic tape, and the multi-channel head 1 is allowed to reciprocate in a shift direction (or a track width direction) S perpendicular to an alternating travel direction T of the magnetic medium 103.

In case of LTO, as well known in the art, the magnetic medium 103 should have a width of ½ inch for writing and reading. Accordingly, the multi-channel head 1 has a plurality of write elements, a plurality of read elements, and two servo read elements.

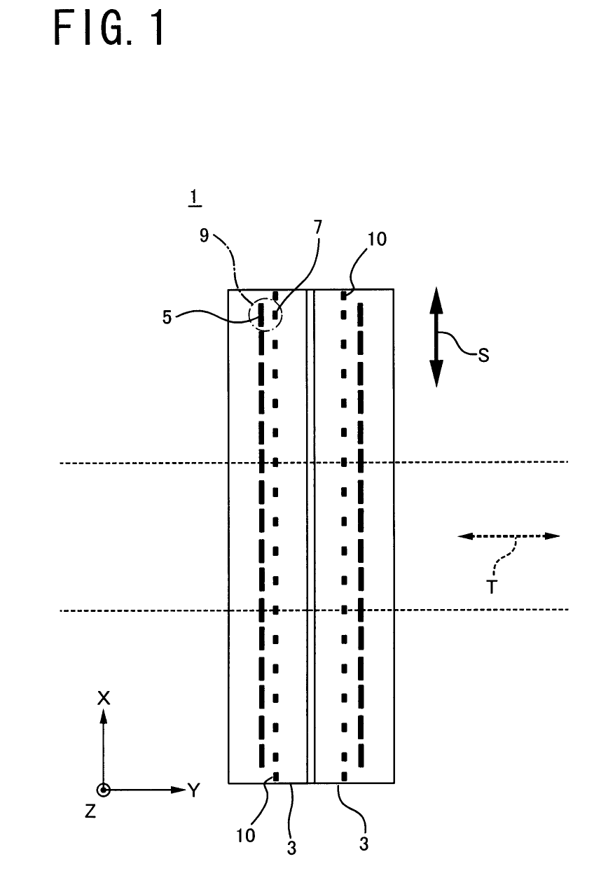

FIG. 1 shows a multi-channel head of the present embodiment. The multi-channel head 1 is constructed by symmetrically bonding together two strip-shaped head chips 3.

The term “head chip” as used herein refers to a chip in which a plurality of elements are arranged in a head shift direction, which will be described later, and at least one array along a relative travel direction with respect to a magnetic medium includes only one of at least either of write and read elements of a plurality of elements.

Each head chip 3 comprises a plurality of write elements 5 and a plurality of read elements 7. The term “head chip” as used herein refers to a chip in which a plurality of elements are arranged in a head shift direction S, which will be described later, and at least one array along a relative travel direction T with respect to a magnetic medium includes only one of at least either of write and read elements of a plurality of elements.

More specifically, one write element 5 and one read element 7 constitute one element pair 9, and in the present embodiment, for example, each head chip 3 has sixteen element pairs 9. The element pairs 9 are arranged in a track width direction X, which is parallel to a shift direction S of the multi-channel head 1, which will be described later, and substantially perpendicular to a travel direction T (or a deposition direction Y) of the linear tape 11. At both ends in the head shift direction S, moreover, each head chip 3 has servo read elements 10 which have the same structure as the primary read elements 7.

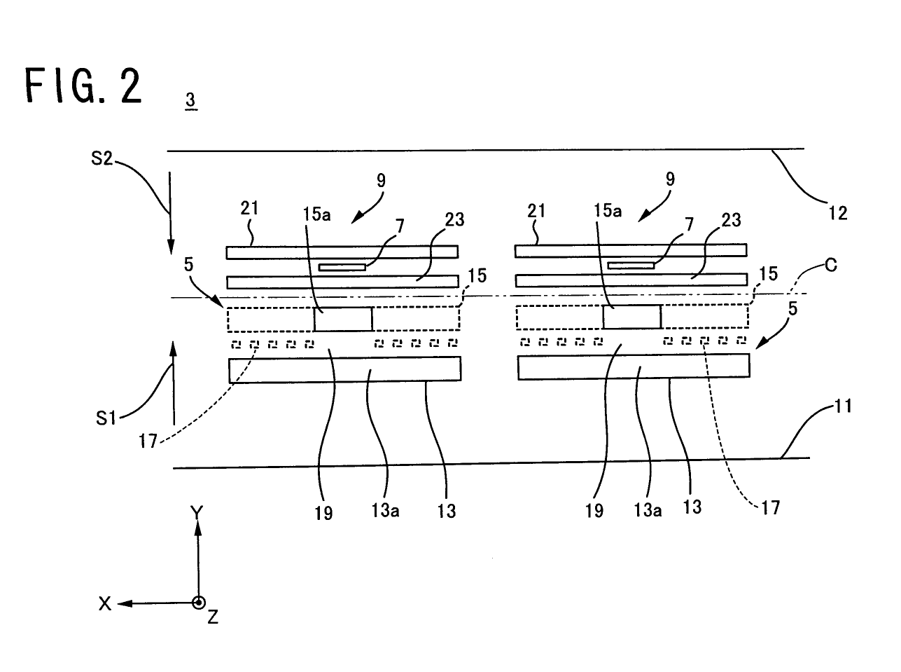

Next will be described principal parts of the head chip with reference to FIG. 2. FIG. 2 is a partially enlarged end view showing a few (two) element pairs in the head chip, which is seen from a medium (linear tape)-facing surface side.

The head chip 3 can be obtained such that the write elements 5 and the read elements 7 are separately deposited, cut out of different wafers and then bonded together. In FIG. 2, a bonding interface C between the write elements 5 and the read elements 7 is indicated by an alternate long and two short dashes line. Also in FIG. 2, the symbols S1, S2 indicate the directions in which layers have been deposited on the substrates 11, 12, respectively. Above the substrate 11 in the deposition direction S1, a plurality of write elements 5 are arranged in the track width direction X. On the other side of the bonding interface C and above the substrate 12 in the deposition direction S2, meanwhile, a plurality of read elements 7 are arranged in the track width direction X. That is, a plurality of read elements 7 are disposed only on one side of the bonding interface C, while a plurality of write elements 5 are disposed only on the other side thereof.

As shown in FIG. 2, the write element 5 includes a lower yoke 13 including a lower pole portion 13a, an upper yoke 15 including an upper pole portion 15a, a coil 17, and a gap film 19. The read element 7 is a magneto-resistive film such as a GMR or TMR film. Above and below the read element 7 in the deposition direction Y, there are disposed an upper magnetic shield 21 and a lower magnetic shield 23, respectively.

Next will be described a production process of the multi-channel head 1 having the above configuration. In the present production process, which is different from a conventional production process where the write elements and the read elements are continuously deposited on a single wafer and then cut out of the wafer as a head chip, the head chip 3 can be obtained through the following steps. Here, deposition and patterning themselves may be performed by conventional processes, and therefore their detailed description is omitted.

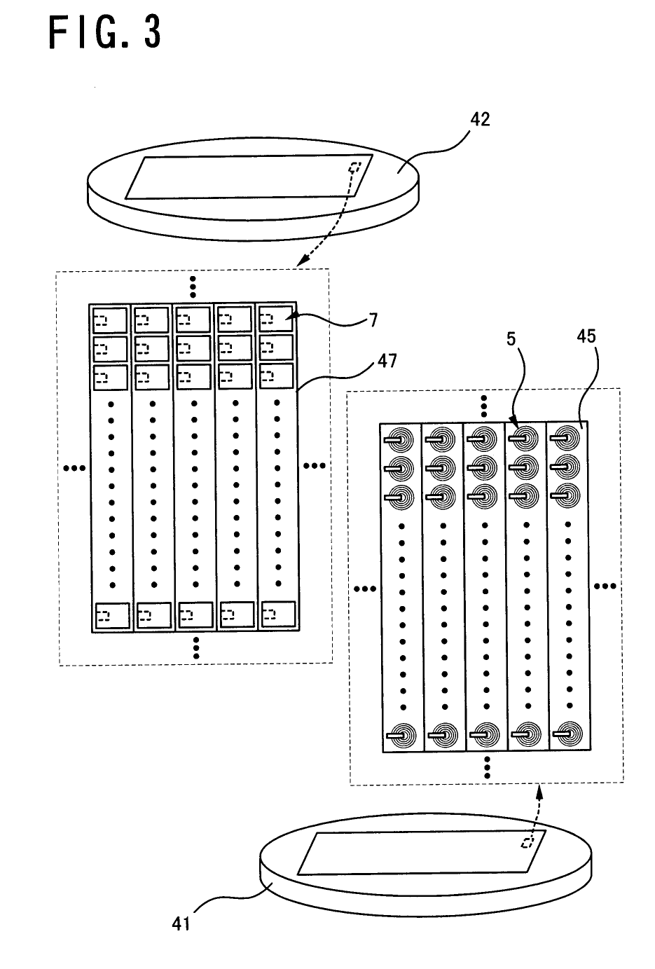

At first, as shown in FIG. 3, a number of write element blocks 45 each including a plurality of write elements 5 are deposited on a first wafer 41 and cut out by a conventional process, thereby obtaining a number of strip-shaped write element blocks 45 as laminates. Meanwhile, a number of read element blocks 47 each including a plurality of read elements 7 are deposited on a second wafer 42 and cut out by a conventional process, thereby obtaining a number of strip-shaped read element blocks 47 as laminates.

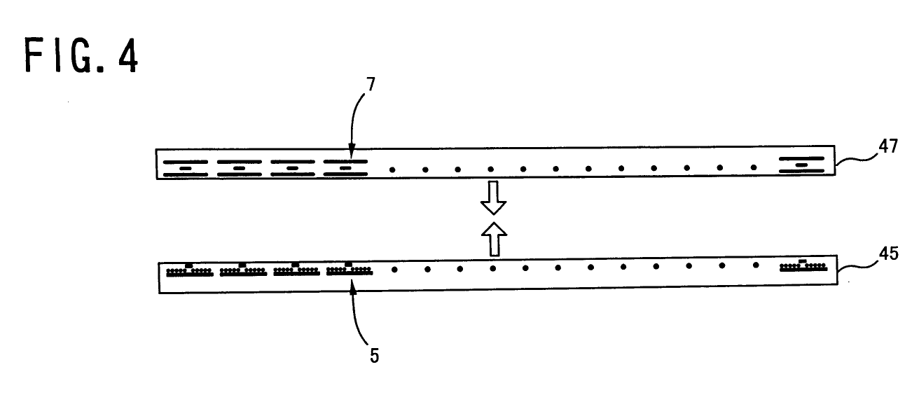

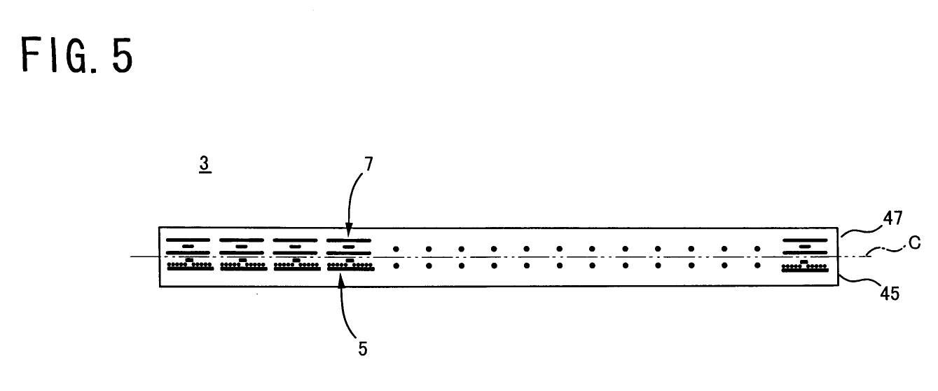

Then, the write element block 45 and the read element block 47 thus cut out separately are bonded together in such a manner that the write elements 5 face the read elements 7, as shown in FIG. 4. Thus, the head chip 3 can be obtained with corresponding ones of the write and read elements 5, 7 facing each other across the bonding interface C, as shown in FIG. 5. Furthermore, two head chips 3 thus obtained are symmetrically bonded together into the multi-channel head 1, as set forth above.

According to the above described embodiment, the yield of the multi-channel head, which has been inferior to that of the ordinary magnetic head, can be enhanced by separately depositing the write and read elements on wafers without changing the structure of the multi-channel head itself.

More specifically, the write and read elements have been heretofore deposited continuously in the deposition direction. Therefore, even if either write or read elements are defective but the other elements are not defective in the completed multi-channel head, the whole multi-channel head will be rejected as a defective. According to the foregoing embodiment, on the other hand, the write element blocks 45 and the read element blocks 47, which are to be bonded together after at least one of them is cut out of a wafer after the completion of deposition, can be tested for failure after the cutting and before the bonding, thereby avoiding the possibility that some of the write and read elements 5, 7 will be found defective after the completion as the bonded head chip 3.

Furthermore, there can be shortened the manufacture lead time because the number of layers becomes fewer in the individual laminates constituting a single head chip. Particularly when the write element block only of the write elements and the read element block only of the read elements are separately prepared as laminates, the manufacture lead time can be further shortened because deposition may be performed separately and in parallel for different elements.

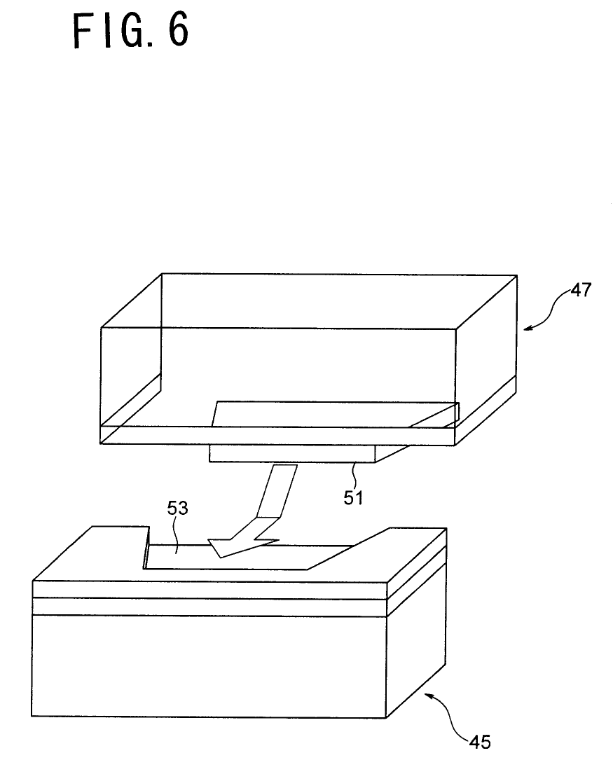

Next will be described several ways to set the position of the write element block 45 and the read element block 47 upon bonding. First, as show in FIG. 6, a projection 51 and a recess 53, which are mutually engageable and forms a joint, may be disposed in either of the write element block 45 and the read element block 47 and in the other, respectively, so that positioning can be performed by detecting engagement between the projection 51 and the recess 53. In the embodiment shown in FIG. 6, for example, the read element block 47 has the projection 51. This positioning method realizes more accurate positioning because the position can be set by a physical state, i.e., engagement between the projection 51 and the recess 53. The formation of the projection and the recess may be performed by appropriately combining well-known processes such as deposition, masking, etching and flattening.

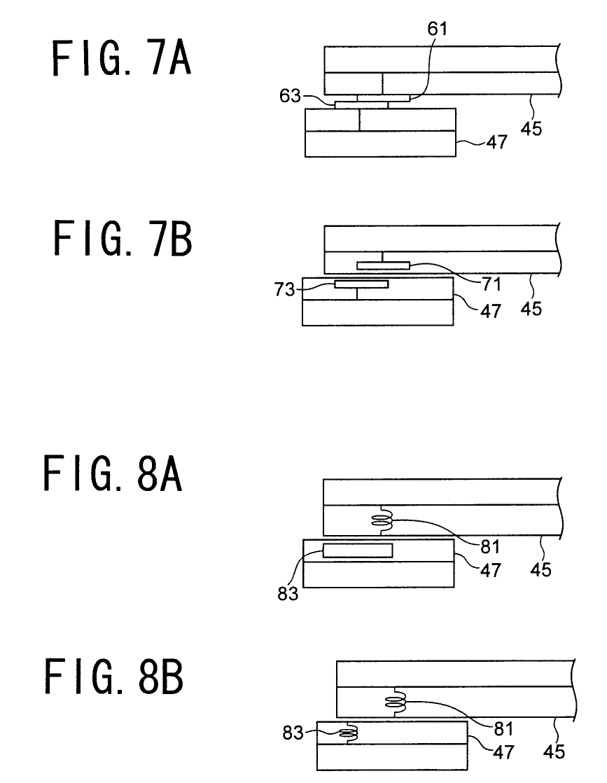

Second, as shown in FIG. 7A, positioning pads 61, 63 may be disposed at connecting portions of the write element block 45 and the read element block 47, respectively, so that positioning can be performed by detecting a change in electrical resistance between the positioning pads 61, 63. That is, the electrical resistance between the pads should be measured with a voltage applied between the positioning pads 61, 63, which are made of a conductive layer. The value of the electrical resistance will be reduced to a minimum when the contact area between the positioning pads 61, 63 is the largest, i.e., when the positioning pads 61, 63 are superposed on each other in the illustrated embodiment, which enables appropriate positioning of the write element block 45 and the read element block 47.

It should be noted that as long as the relative position of the write element block 45 and the read element block 47 can be determined by a change in electrical resistance, the positioning pads 61, 63 may be provided in any size, shape, number and arrangement without limitation.

Third, as shown in FIG. 7B, capacitor forming electrodes 71, 73, which act as a capacitor, may be disposed in the write element block 45 and the read element block 47, respectively, so that positioning can be performed by detecting a change in capacitance between them.

Fourth, as shown in FIG. 8, a coil 81 may be disposed in either of the write element block 45 and the read element block 47, while a magnetic field generating device 83 may be disposed in the other, so that positioning can be performed by detecting a change in inductance between them. In the embodiments shown in FIG. 8, for example, the read element block 47 has the magnetic field generating device 83. Here, the magnetic field generating device 83 is not limited to any particular structure and may be made of, for example, a magnetic material layer or a magnet, as shown in FIG. 8A, or an electromagnet, as shown in FIG. 8B.

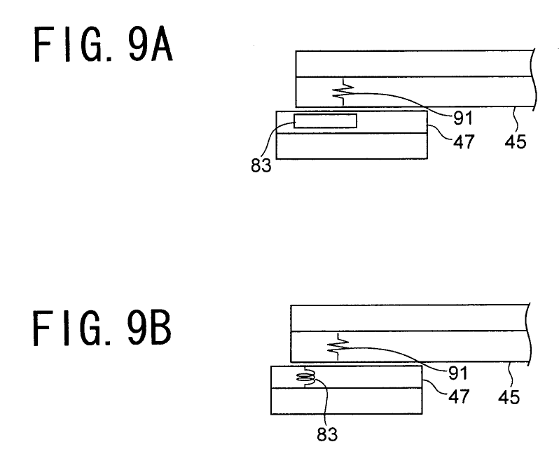

Fifth, as shown in FIG. 9, a magneto-resistive element 91 may be disposed in either of the write element block 45 and the read element block 47, while the magnetic field generating device 83 may be disposed in the other, so that positioning can be performed by detecting magneto-resistive effect.

While the present invention has been specifically described with reference to preferred embodiments thereof, it will be understood by those skilled in the art that various changes may be made therein on the basis of the basic technical concept and teaching of the invention.

More specifically, the head chip of the present invention may have any configuration as long as at least one array along a relative travel direction with respect to a magnetic medium includes only one of at least either of write and read elements of a plurality of elements. The head chip may also have any configuration as long as having at least one bonding interface. It may also have any configuration as long as at least one element is disposed on one side of the bonding interface, and at least one element is also disposed on the other side thereof. Hence the following configurations are possible.

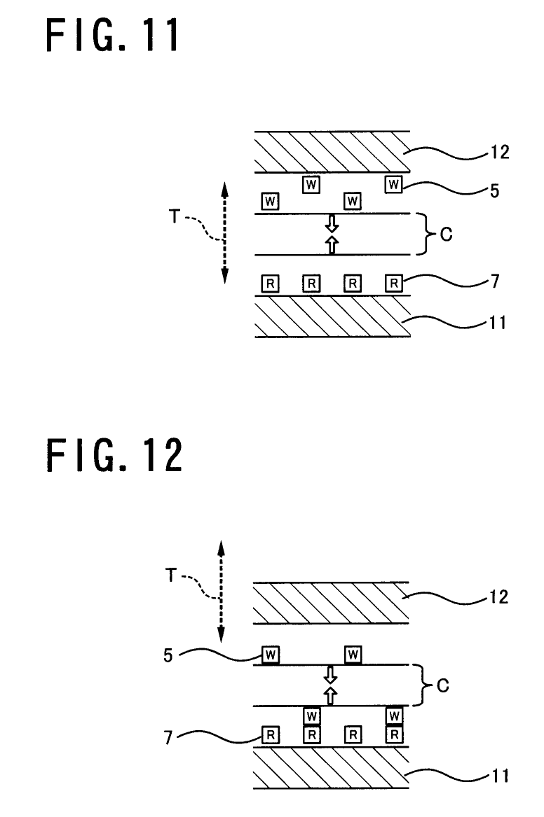

The head chip may be configured as shown in FIG. 11, wherein it has a single bonding interface C, only write elements 5 are disposed on one side thereof, only read elements 7 are disposed on the other side thereof, any array along the relative travel direction T includes only one write element and only one read element, and a plurality of write elements are staggered in the relative travel direction T. This embodiment has not only the same advantages as the foregoing embodiment but also an additional advantage that the distance between write elements can be shortened because the write elements are staggered in the relative travel direction, thereby achieving a smaller pitch (This is also true for the embodiments of FIGS. 12 to 18).

The head chip may also be configured as shown in FIG. 12, wherein it has a single bonding interface C, and any array along the relative travel direction T includes only one write element 5 and only one read element 7. Concerning the arrays along the relative travel direction T, moreover, one array includes only the write element 5 but another array includes no element on one side of the bonding interface C, while one array includes only the read element 7 but another array includes both the write and read elements 5, 7 on the other side thereof.

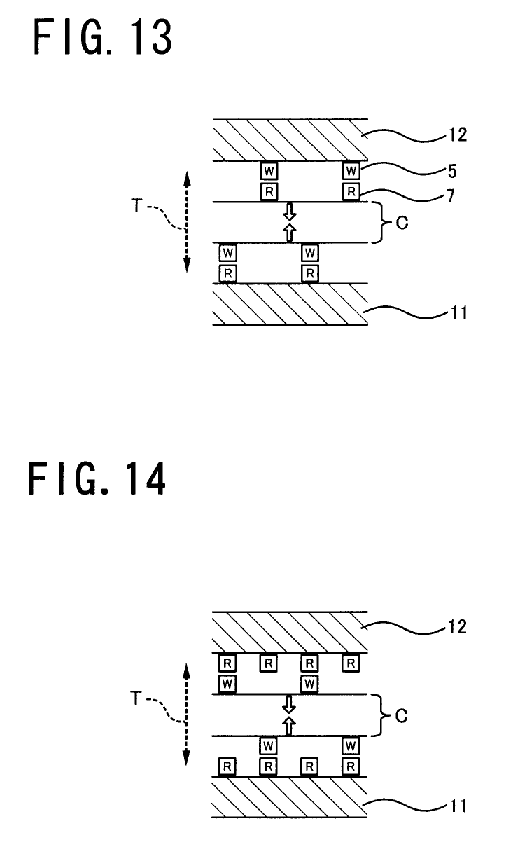

The head chip may also be configured as shown in FIG. 13, wherein it has a single bonding interface C, and any array along the relative travel direction T includes only one write element 5 and only one read element 7. Concerning the arrays along the relative travel direction T, moreover, both the write and read elements 5, 7 are together disposed on one side or the other side of the bonding interface C.

The head chip may also be configured as shown in FIG. 14, wherein it has a single bonding interface C, and any array along the relative travel direction T includes one write element 5 and a plurality of read elements 7 (two read elements in the illustrated embodiment). Concerning the arrays along the relative travel direction T, moreover, one array includes both write and read elements 5, 7 on one side of the bonding interface C and only one read element 7 on the other side thereof, while another array includes only one read element 7 on one side of the bonding interface C and both write and read elements 5, 7 on the other side thereof.

This embodiment may be modified such that any array along the relative travel direction T includes a plurality of write elements 5 and one read element 7, and it may also be modified such that concerning the arrays along the relative travel direction T, the arrays including one write element 5 and a plurality of read elements 7 are mixed with the arrays including a plurality of write elements 5 and one read element 7.

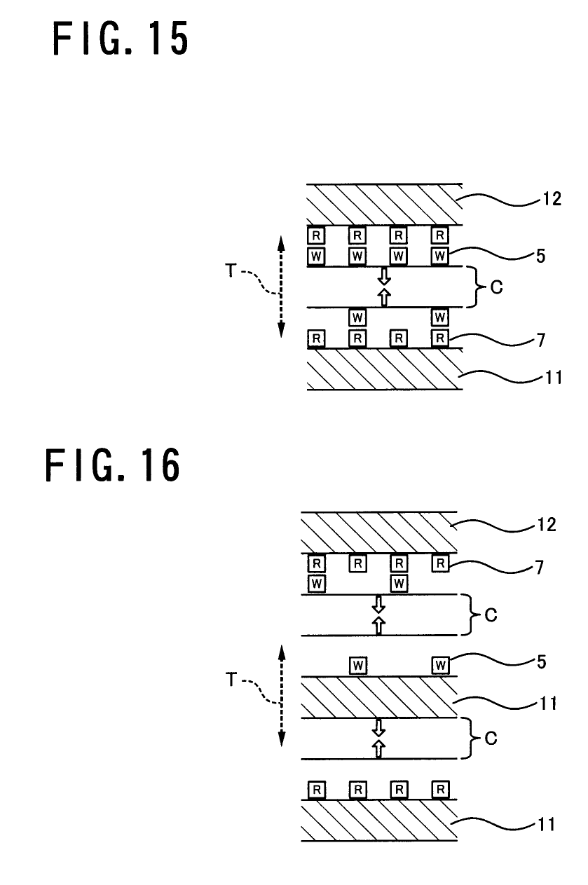

As shown in FIG. 15, it should also be noted that the head chip is not limited to the embodiments in which the number of write and read elements 5, 7 is the same in all the arrays along the relative travel direction T. In the embodiment shown in FIG. 15, accordingly, concerning the arrays along the relative travel direction T, arrays including one write element 5 and a plurality of read elements 7 (two read elements in the illustrated embodiment) are mixed with arrays including a plurality of write elements 5 and a plurality of read elements 7 (two write elements and read elements in the illustrated embodiment). Even in this configuration, at least one array (every two arrays in the illustrated embodiment) along the relative travel direction T includes only one of at least either of write and read elements of a plurality of elements (the write element 5 in the illustrated embodiment). Concerning the arrays along the relative travel direction T, moreover, one array includes both write and read elements 5, 7 on one side of the bonding interface C and only one read element 7 on the other side thereof, while another array includes both write and read elements 5, 7 on both sides of the bonding interface C. Compared with the embodiment shown in FIG. 14, it is also possible to dispose write elements between write elements of a different format.

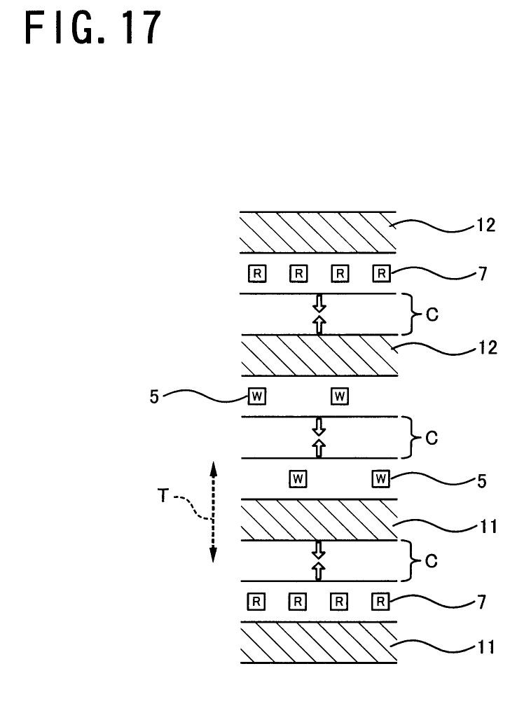

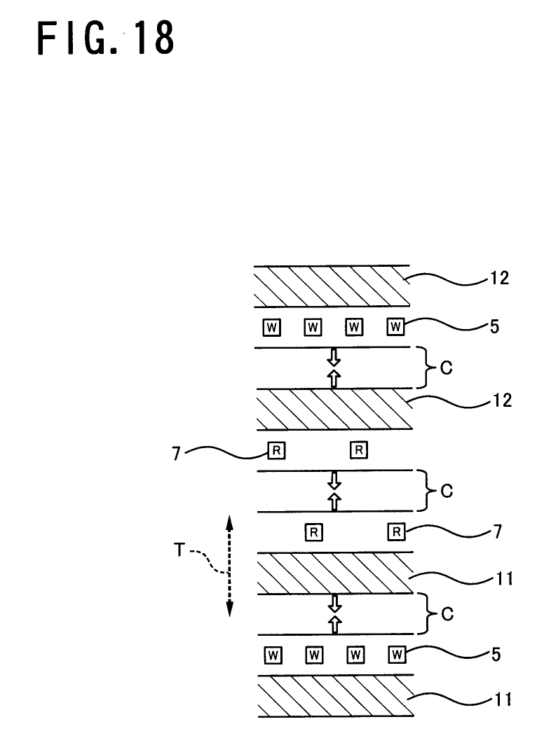

As shown in FIGS. 16 to 18, furthermore, the head chip may have a plurality of bonding interfaces C (two bonding interfaces in the embodiment of FIG. 16; three bonding interfaces in the embodiments of FIGS. 17 and 18). Even in these configurations, at least one array (all the arrays in the illustrated embodiments) along the relative travel direction T includes only one write element 5 of a plurality of elements.

Still furthermore, the multi-channel head according to the present invention is not limited to having a plurality of write elements and a plurality of read elements and may have only a plurality of write elements or only a plurality of read elements. Moreover, although the write and read element blocks are obtained from different wafers in the foregoing embodiment, the present invention is not limited thereto and they may be obtained from a common wafer.

The present invention is also applicable to any type of multi-channel tape drive, disk drive and drum drive.

What is claimed is:

1. A multi-channel head comprising at least one head chip having a plurality of elements and at least one bonding interface,
wherein said head chip has at least one element on one side of said bonding interface and at least one element on the other side of said bonding interface.

2. The multi-channel head of claim 1, wherein of said plurality of elements, only a plurality of read elements, except any servo read element for reading servo information, are disposed on one side of said bonding interface while only a plurality of write elements are disposed on the other side of said bonding interface.

3. The multi-channel head of claim 1, wherein said plurality of elements include a plurality of write elements arranged in a head shift direction and staggered in a relative travel direction with respect to a magnetic medium.

4. The multi-channel head of claim 1, wherein said head chip has a plurality of bonding interfaces.

5. A magnetic media device comprising:
said multi-channel head of claim 1;
a magnetic medium facing said multi-channel head; and
a drive system for relatively moving said magnetic medium and said multi-channel head.

6. A magnetic media device comprising:
said multi-channel head of claim 2;
a magnetic medium facing said multi-channel head; and
a drive system for relatively moving said magnetic medium and said multi-channel head.

7. A magnetic media device comprising:
said multi-channel head of claim 3;
a magnetic medium facing said multi-channel head; and
a drive system for relatively moving said magnetic medium and said multi-channel head.

8. A magnetic media device comprising:
said multi-channel head of claim 4;
a magnetic medium facing said multi-channel head; and
a drive system for relatively moving said magnetic medium and said multi-channel head.

9. A method for manufacturing a multi-channel head having at least one head chip, comprising:
preparing a plurality of laminates each having at least one element; and
bonding together said plurality of laminates into said one head chip.

10. The multi-channel head manufacturing method of claim 9, wherein said plurality of laminates comprise a write element block including at least one said write element and a read element block including at least one said read element, except any servo read element for reading servo information,
wherein said plurality of write elements and said plurality of read elements are deposited on different wafers,
said write element block and said read element block are respectively obtained from corresponding one of said wafers, and
said write element block and said read element block are bonded together.

11. The multi-channel head manufacturing method of claim 9, wherein positioning upon said bonding is performed by providing the element blocks with mutually engageable projection and recess and detecting engagement therebetween.

12. The multi-channel head manufacturing method of claim 9, wherein positioning upon said bonding is performed by detecting a change in electrical resistance between connecting portions of said element blocks.

13. The multi-channel head manufacturing method of claim 9, wherein positioning upon said bonding is performed by providing each element block with a capacitor forming electrode which acts as a capacitor and detecting a change in capacitance.

14. The multi-channel head manufacturing method of claim 9, wherein positioning upon said bonding is performed by providing one of said element blocks with a coil and the other with a magnetic field generating device and detecting a change in inductance.

15. The multi-channel head manufacturing method of claim 9, wherein positioning upon said bonding is performed by providing one of said element blocks with a magneto-resistive element and the other with a magnetic field generating device and using magneto-resistive effect.
